(19) United States
(12) Patent Application Publication
(10) Pub. No.: US 2005/0275249 A1
(43) Pub. Date: Dec. 15, 2005

(54) Hybrid structural component

(76) Inventors: Gottfried Sailer, Schorndorf (DE); Ernst Martin, Neuhausen (DE)

Correspondence Address: CLARK HILL, P.C., 500 WOODWARD AVENUE, SUITE 3500, DETROIT, MI, 48226, US

(21) Appl. No.: 11/149,406

(22) Filed: Jun. 9, 2005

(30) Foreign Application Priority Data
Jun. 9, 2004 (DE) 10 2004 029 031.8

(51) Int. Cl. B62D 25/08

(52) U.S. Cl. 296/193.09

(57) ABSTRACT

A hybrid structural component includes a core and a plastic outer body. The plastic outer body is molded at least partially around the core. At least one fixing arrangement is formed on the plastic outer body for accommodating an elongate flexible component.

### FIELD OF THE INVENTION

The invention relates to a hybrid structural component for use in a motor vehicle. More specifically, the invention relates to a hybrid structural component that allows for greater degree of integration.

### DESCRIPTION OF RELATED ART

Significant progress has been made in recent times in the technology of plastics and metal composites, also known as hybrid technology, for the manufacture of structural components of optimum weight and reasonable costs. Hybrid technology by definition refers to the combination of a plurality of materials to form an integrative system solution. Generally, a core of a high strength material such as steel or the like is surrounded by injection molding with a plastic material, resulting in a component with a high degree of integration. These components are utilized for fixing to other components or for securing other components. Structural components produced by hybrid technology have already proved their worth in a number of mass produced applications, e.g. in front end carriers in motor vehicles.

EP 0370342 D1 discloses a lightweight component produced by hybrid technology wherein reinforcing ribs made of injection molded plastics are provided in a dish-shaped basic member made of sheet steel.

EP 0995668 A1 discloses a lightweight hollow chamber component that includes a dish-shaped housing part of high strength material, in this case a metal. A ribbed support structure made of plastics is provided therein as reinforcement for the dish-shaped housing part.

A common feature in these lightweight components is that the plastic used therein essentially forms a rib-like structure that is placed inside the dish-shaped housing part made of metal as a reinforcement. On the other hand, an outer surface of the lightweight component in question has only a smooth structure without any further integrated elements.

Accordingly, it would be desirable to provide a hybrid structural component that guarantees a greater degree of integration.

A hybrid structural component according to the invention is particularly suitable for accommodating an elongate flexible means such as a cable, pull cable or the like, in particular, wherein a fixing arrangement which is adapted to accommodate the elongate flexible means is formed on an outer body made of plastics with which the core of the hybrid structural component is at least partly surrounded by injection molding.

When the hybrid structural component is used, for example, as a front end module in a motor vehicle, any flexible components which would otherwise be lying loose, such as fluid hoses, electric cables, pull cables and the like may be easily inserted in the fixing arrangement formed on the outer body. This prevents damage to the flexible components, thereby increasing the operational reliability of the motor vehicle. Furthermore, there is no longer any need to clip, secure or otherwise attach the above-mentioned flexible components to other holders in the engine compartment, resulting in a significantly reduced assembly time on the production line and hence lower manufacturing costs.

The fixing arrangement may be formed from two bars arranged substantially parallel to one another and spaced from one another, each projecting from a surface of the plastic outer body. The spacing between the bars is suitably selected so that the flexible component is held or guided between the bars. The spacing of the bars and their heights are expediently matched to a diameter of the flexible component so that the flexible components are effectively prevented from slipping out of the fixing arrangement.

The bars may be flexible relative to one another in one direction. Thus, even if the diameter of the flexible means is not precisely matched to the spacing between the two bars, the flexible means can be placed in the fixing arrangement, i.e. between the two bars, by suitable deformation of the bars.

At least one of the bars may have a flange on its free end face. The flange extends substantially parallel to the surface of the outer plastics body and in the direction of the opposite bar. If the flexible component is introduced in the region between the bars, the flange can be clipped to the bar opposite it, thereby closing off the space between the bars at the top. This prevents the flexible means from unintentionally sliding out in the event of vibration or other forces.

The fixing arrangement may have a first bar and, on both sides thereof, a second and a third bar. The bars are arranged along an axis, the first bar on the one hand and the second and third bars on the other hand being spaced apart in relation to the axis. Expediently, the bars may also have a flange on a free end face, the flange extending substantially parallel to the surface of the outer plastics body and in the direction of the other bar or bars, so as to avoid unintentional slipping of the flexible means out of an area between the bars in a direction opposite to the surface of the outer plastics body. This is particularly suitable for fixing large-volume flexible components, e.g. in the form of wiring harnesses or the like.

In addition to the conventionally known mounting points provided on the outer plastic body for assembly with adjacent structural parts, such as vehicle bodywork or the like, the at least one fixing arrangement is also provided on the outer plastic body, which is adapted to accommodate the flexible component such as a cable or the like, in particular. A fixing arrangement of this kind can be produced in the same way as the above-mentioned conventional mounting points, that is, during the injection molding process in which the core is at least partially surrounded by the plastic via injection molding. Thus, the fixing arrangement for accommodating the flexible means does not involve any increase, or at least any appreciable increase, in the manufacturing costs. As a result, cables or the like can thus be mounted on the hybrid structural component at very low cost and within a significantly shorter assembly time.

### SUMMARY OF THE INVENTION

A hybrid structural component includes a core and a plastic outer body. The plastic outer body is molded at least partially around the core. At least one fixing arrangement is formed on the plastic outer body for accommodating an elongate flexible component.

### BRIEF DESCRIPTION OF THE DRAWINGS

Advantages of the present invention will be readily appreciated as the same become better understood by reference to the following detailed description of the preferred embodiment when considered in connection with the accompanying drawings wherein:

FIG. 1 shows a hybrid structural component according to the invention in a simplified perspective side view;

FIG. 2 shows a simplified view of an outer plastics body of the hybrid structural component of FIG. 1 with fixing arrangements formed thereon;

FIG. 3 shows the area 1 of FIG. 2 in an enlarged view;

FIG. 4 shows the fixing arrangement of FIG. 3 in a further view; and

FIG. 5 shows a fixing arrangement in another embodiment.

### DETAILED DESCRIPTION OF THE PREFERRED EMBODIMENT

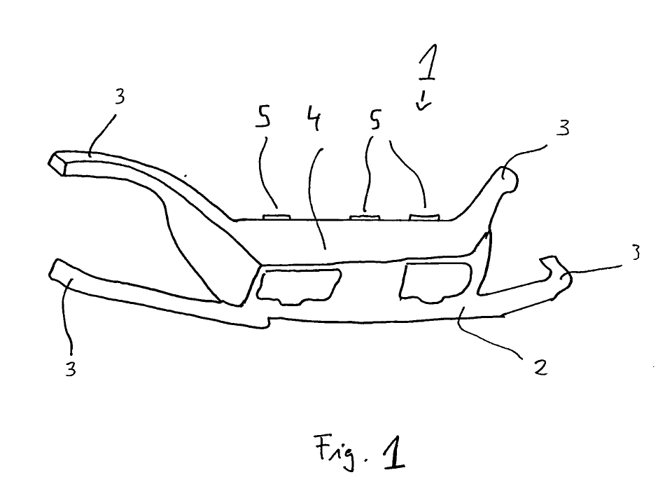

Referring to FIG. 1, a hybrid structural component 1 is designed as a front end module for a motor vehicle. The hybrid structural component 1 is produced by hybrid technology, which is sufficiently well-known and will not be described in more detail here, and has a core (not visible) that is at least partly surrounded by an outer body 2 made of injection molded plastics. For a high degree of integration, various mounting points or structures 3 are formed on the plastic outer body 2 such that the hybrid structural component 1 can be secured to corresponding parts of a motor vehicle body or to which other units of an engine or the like can be attached.

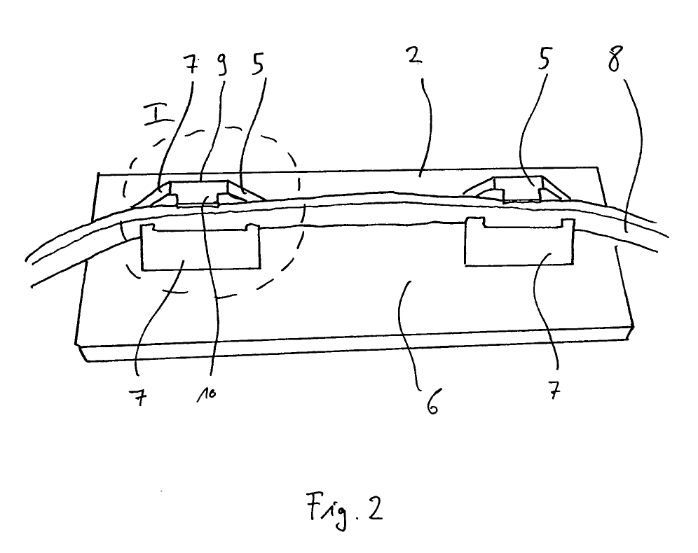

A plurality of individual fixing elements 5 is formed on an upper edge of a central part 4 of the hybrid structural component 1. The plurality of individual fixing elements 5 is designed to accommodate an elongate flexible part such as, in particular, a cable, a pull cable or the like and is hereinafter described in detail with reference to FIGS. 2 through 4.

Referring to FIG. 2, a surface 6 of the plastic outer body 2 is formed to support the plurality of fixing elements 5. The plurality of fixing elements 5 may readily be provided on the plastic outer body 2 in order to guide an elongate flexible component along its length.

Each of the plurality of fixing elements 5 is formed from two bars 7 which are arranged substantially parallel and spaced apart from one another to one another, and project from the surface 6 of the plastic outer body 2. The spacing of the two bars 7 from one another is suitably selected so that a flexible component 8 such as, for example, a cable or the like can be guided between the bars 7. The cable 8 can be guided along its length over the hybrid structural component 1 by the plurality of fixing elements 5, which are provided at set intervals from one another on the plastic outer body 2.

One of the bars 7 may have, on its free end face 9, a flange 10 that extends substantially parallel to the surface 6 of the plastic outer body 2 and in the direction of the opposite bar. The flange 10 lies at least partially over the cable 8 from above, when the cable 8 is positioned between the bars 7, so that it is not readily possible for the cable 8 to be pulled accidentally out of the area between the bars 7.

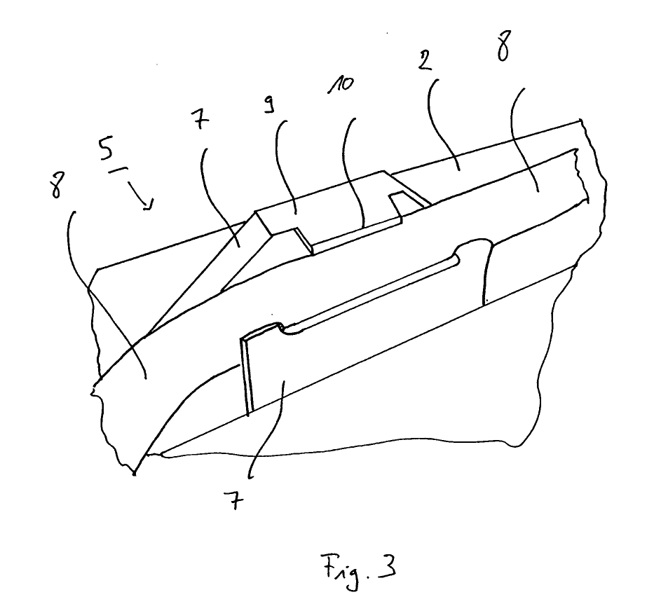

Referring to FIG. 3, the cable 8 is guided or clamped between the sidewalls of the two bars 7 and thereby held against the hybrid structural component 1. The flange 10 lies at least partially over the cable 8 from above, in order to prevent the cable 8 from being automatically pulled out at the top, as explained above. Alternatively, the flange 10 may also be substantially longer, i.e. in the direction of the opposite bar, so as to engage with a free end face of the other bar. Thus, the cable 8 could also be guided “overhead” without the force of gravity causing the cable 8 to slip out of the area between the bars 7.

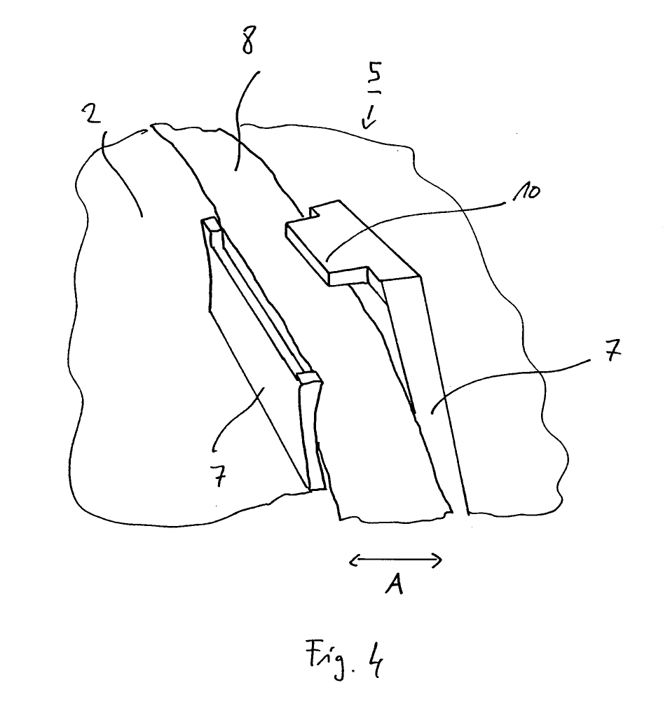

Referring to FIG. 4, the wall thickness of the two bars 7 is relatively thin, so that the bars 7 are flexible relative to one another in one direction. This is indicated accordingly by the arrow A in FIG. 4. If the cable 8 having a diameter slightly greater than the spacing between the two bars 7 is inserted therebetween, the bars 7 are forced apart relative to one another, i.e. to the left and right in the view shown in FIG. 4, so that the difference between the diameter of the cable 8 and the spacing of the bars 7 is advantageously compensated. To put it another way, the flexibility of the two bars 7 relative to one another when the cable 8 is inserted in the fixing element 5 makes it possible to compensate for minor changes in the cross-section of the cable 8.

In the same way as the cable 8, other parts that are flexible in the longitudinal direction, such as a pull cable, a fluid hose or the like, can be held or guided by the fixing element 5 on the hybrid structural component 1.

The fixing element 5 with its two bars 7 can be produced in the same way as the other mounting points 3, that is, via injection molding using the “one-shot principle”, for which the injection molding tool essentially needs no major modifications. This is beneficial in terms of the overall manufacturing costs of the hybrid structural component 1. By means of the fixing element 5, the hybrid structural component 1 thus allows integration of a flexible component, e.g. in the form of a cable, a pull cable, a hose connection or the like, as explained above, without the need for a sliding tool or without having to secure the above mentioned flexible component separately using a fastening clip. In addition, the flexibility of the two bars 7 as described above makes it possible to adapt to different diameters of the elements which are to be assembled.

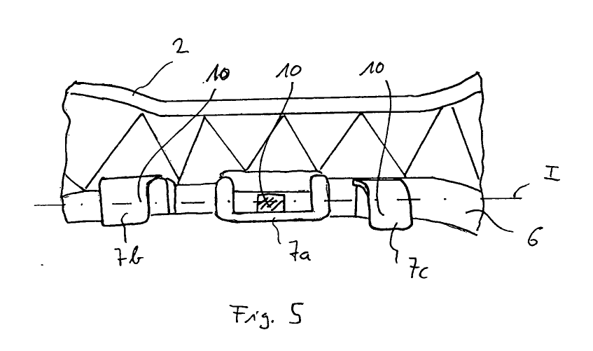

Referring to FIG. 5, a hybrid structural component 1 includes a fixing arrangement having a first central bar 7a and, on both sides thereof, second bars 7b and 7c. The bars 7a, 7b, 7c are arranged along an axis I, the first bar 7a being spaced apart from the second 7b and third 7c bars in relation to the axis I. The bars 7a, 7b, 7c have a flange 10 on a free end face. The flange 10 extends substantially parallel to the surface 6 of the plastic outer body 2 and in the direction of the axis I. Thus, in one region along the axis I, the bars 7a, 7b, 7c grip or fix a flexible component, particularly with a large diameter, while the flanges 10 effectively prevent accidental movement of the flexible component in a direction away from the surface 6 of the plastic outer body 2. The flexible components of large and/or non-uniform diameter can be threaded easily between the bars 7a, 7b, 7c.

The core (not shown) of the hybrid structural component 1 be formed from a metal, such as a steel or the like, or a fiber-reinforced plastic or the like. Moreover, the core may either be fully enclosed by the injection molded plastic outer body 2 or may be at least partially surrounded thereby with a view to easier monitoring of the process.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

1. A hybrid structural component comprising:
a core;
a plastic outer body molded at least partially around the core; and
the plastic outer body having at least one fixing arrangement formed on the outer body for accommodating an elongate flexible component.

2. A hybrid structural component as set forth in claim 1 wherein the fixing arrangement includes a plurality of bars each projecting from a surface of the plastic outer body.

3. A hybrid structural component as set forth in claim 2 wherein the fixing arrangement is formed by a pair of substantially parallel and spaced apart bars.

4. A hybrid structural component as set forth in claim 3 wherein at least one of the pair of bars includes on a free end face a flange extending substantially parallel to the surface of the plastic outer body and in the direction of the opposing bar.

5. A hybrid structural component as set forth in claim 4 wherein the flange is latched to a free end face of the opposing bar.

6. A hybrid structural component as set forth in claim 5 wherein the fixing arrangement includes a first bar and on both sides thereof a second bar and a third bar, the bars being arranged along an axis such that the first, second, and third bars are spaced apart from one another in relation to the axis.

7. A hybrid structural component according to claim 6 wherein at least one of the first, second, and third bars includes a flange on a free end extending substantially parallel to the surface of the plastic outer body and in the direction of the axis.

8. A hybrid structural component as set forth in claim 7 wherein the bars are flexible in one direction relative to one another.

9. A hybrid structural component as set forth in claim 8 wherein the core has a closed cross-sectional profile.

10. A hybrid structural component as set forth in claim 9 wherein the core is completely surrounded by the plastic outer body.

11. A hybrid structural component as set forth in claim 10 including at least one other fixing element formed on the outer body for fixing the hybrid structural component to another structural element.

12. A hybrid structural component as set forth in claim 11 wherein the core is formed from metal.

13. A hybrid structural component as set forth in claim 11 wherein the core is formed from fiber-reinforced plastic.

14. A hybrid structural component as set forth in claim 11 wherein the at least one other fixing element is secured to the bodywork of a motor vehicle.

15. A hybrid structural component as set forth in claim 14 wherein the core and plastic outer body act as a front module for a motor vehicle.
